(19) United States
(12) Patent Application Publication
(10) Pub. No.: US 2024/0152636 A1
(43) Pub. Date: May 9, 2024

(54) ELECTRONIC DEVICE AND METHOD FOR VERIFYING DATA IN ELECTRONIC DEVICE

(71) Applicant: SAMSUNG ELECTRONICS CO., LTD., Suwon-si (KR)

(72) Inventors: Kyungsun CHO, Suwon-si (KR); Woochul SHIM, Suwon-si (KR)

(73) Assignee: SAMSUNG ELECTRONICS CO., LTD., Suwon-si (KR)

(21) Appl. No.: 18/386,823

(22) Filed: Nov. 3, 2023

Related U.S. Application Data
(63) Continuation of application No. PCT/KR23/17427, filed on Nov. 2, 2023.

(30) Foreign Application Priority Data
Nov. 3, 2022 (KR) 10-2022-0145529

(51) Int. Cl. G06F 21/62

(52) U.S. Cl. CPC G06F 21/62

(57) ABSTRACT

According to an embodiment, an electronic device includes a memory, a first processor coupled to the memory and configured to control the electronic device in a normal execution environment (REE), and a second processor coupled to the memory and configured to control the electronic device in a secure execution environment (TEE). The first processor in the REE may be configured to transfer, to the second processor in the TEE, a request for generating a block including verification data of a data chunk. The second processor may be configured to generate the verification data of the data chunk by using key information of the electronic device, sign the verification data, and transmit, to an external electronic device, the block including the signed verification data.

### CROSS-REFERENCE TO RELATED APPLICATIONS

This application is a continuation of International Application No. PCT/KR2023/017427, filed on Nov. 2, 2023, which claims priority to Korean Patent Application No 10-2022-0145529, filed Nov. 3, 2022, in the Korean Intellectual Property Office, the disclosures of which are incorporated by reference herein in their entireties.

### BACKGROUND

### 1. Field

The present disclosure relates to data communication, and more particularly, to electronic devices for verifying data and method of verifying data by electronic devices.

### 2. Description of Related Art

Blockchains may refer to a data forgery prevention technology based on a distributed computing technology. For example, data to be managed is stored in a distributed data storage environment which is a ‘block’ formed through connections between countless small chunks data in the form of a chain, on the basis of a peer-to-peer (P2P) scheme. Accordingly, no one can arbitrarily modify the data and anyone can view the result of a change in the data.

For example, transaction information propagated to users before the corresponding block is found are recorded in the block and equally transmitted to all users in a P2P scheme, and thus the transaction information cannot be arbitrarily amended or omitted. The block has a link to the data it was found and to the previous block, and a set of blocks is referred to as blockchain.

Blockchain mining is an action of receiving a reward according to completion of a task of adding a block to new blockchain through proof-of-work. However, when a plurality of electronic devices perform blockchain mining within the network, the plurality of electronic devices may have excessive power consumption.

### SUMMARY

According to an embodiment, an electronic device includes a memory, a first processor connected to the memory and configured to control the electronic device in a normal execution environment (REE), and a second processor connected to the memory and configured to control the electronic device in secure execution environment (TEE). The first processor within the normal execution environment may be configured to transfer a request for generating a block including data for verification of a data chunk to the second processor within the secure execution environment. The second processor may be configured to generate the data for verification of the data chunk by using key information of the electronic device and sign the data for verification. The second processor may be configured to transmit the block including the signed data for verification to an external electronic device.

According to an embodiment, the electronic device includes a communication circuit and at least one processor connected to the communication circuit. The at least one processor may be configured to receive a block including data for verification of a data chunk from a first external electronic device through the communication circuit. The at least one processor may be configured to verify the data for verification of the data chunk by using a public key. The at least one processor may be configured to, in case that the data for verification has been completely verified and it is determined that the block received from the first external electronic device is valid, timestamp and sign the block by using key information of the electronic device.

According to an embodiment, a method of operating an electronic device includes transferring a request for generating a block including data for verification of a data chunk from a normal execution environment (REE) to a secure execution environment (TEE). The method of operating the electronic device includes generating the data for verification of the data chunk by using key information of the electronic device in the secure execution environment (TEE). The method of operating the electronic device includes signing the data for verification in the secure execution environment (TEE) and transmitting the block including the signed data for verification to an external electronic device.

According to an embodiment, a method of operating an electronic device includes receiving a block including data for verification of a data chunk from a first external electronic device. The method of operating the electronic device includes verifying the data for verification of the data chunk by using a public key. The method of operating the electronic device includes, in case that the data for verification has been completely verified and it is determined that the block received from the first external electronic device is valid, timestamping and signing the block by using key information of the electronic device.

According to an embodiment, a computer-readable storage medium storing at least one instruction may be provided. The at least one instruction may cause an electronic device to, when executed by at least one processor, perform a plurality of operations. The plurality of operations may include transferring a request for generating a block including data for verification of a data chunk from a normal execution environment (REE) to a secure execution environment (TEE). The plurality of operations may include generating the data for verification of the data chunk by using key information of the electronic device. The plurality of operations may include signing the data for verification and transmitting the block including the signed data for verification to an external electronic device.

According to an embodiment, a computer-readable storage medium storing at least one instruction may be provided. The at least one instruction may cause an electronic device to, when executed by at least one processor, perform a plurality of operations. The plurality of operations may include receiving a block including data for verification of a data chunk from a first external electronic device. The plurality of operations may include verifying the data for verification of the data chunk by using a public key. The plurality of operations may include, in case that the data for verification has been completely verified and it is determined that the block received from the first external electronic device is valid, timestamping and signing the block by using key information of the electronic device.

Additional aspects may be set forth in part in the description which follows and, in part, may be apparent from the description, and/or may be learned by practice of the presented embodiments.

### BRIEF DESCRIPTION OF DRAWINGS

FIG. 1 illustrates a network environment including an electronic device according to an embodiment of the disclosure.

FIG. 2 illustrates an example of a device diagram to describe an operation of an electronic device according to an embodiment of the disclosure.

FIG. 3 illustrates an example of a block structure according to an embodiment of the disclosure.

FIG. 4 illustrates another example of the block structure according to an embodiment of the disclosure.

FIG. 5 illustrates another example of the device diagram to describe the operation of the electronic device according to an embodiment of the disclosure.

FIG. 6 illustrates an example of transmitting a block between nodes in a network according to an embodiment of the disclosure.

FIG. 7 illustrates an example of approving a plurality of blocks in a network according to an embodiment of the disclosure.

FIG. 8 illustrates another example of transmitting a block between nodes in the network according to an embodiment of the disclosure.

FIG. 9 is a flowchart illustrating a method of operating an electronic device according to an embodiment of the disclosure.

FIG. 10 is a flowchart illustrating a method of operating an electronic device according to an embodiment of the disclosure.

FIG. 11 is a block diagram of the electronic device within the network environment, according to an embodiment of the disclosure.

### DETAILED DESCRIPTION

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device). For example, a processor (e.g., the processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Hereinafter, various embodiments of the present disclosure are described with reference to the accompanying drawings.

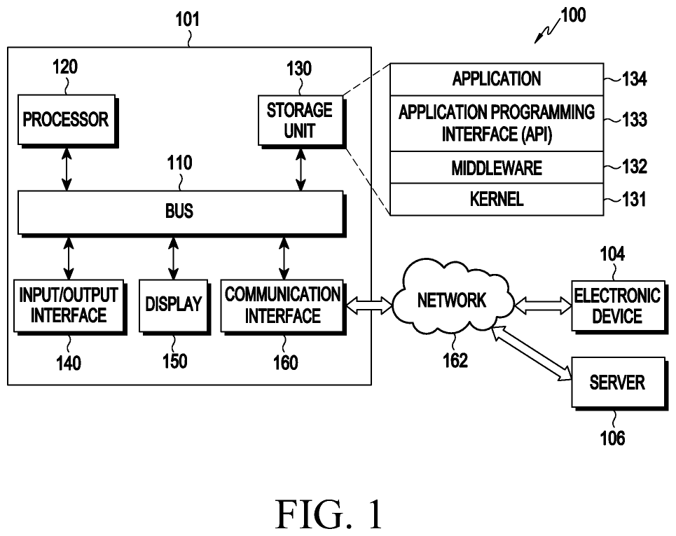

FIG. 1 illustrates a network environment including an electronic device, according to an embodiment of the disclosure.

Referring to FIG. 1, an electronic device 101 may include a bus 110, a processor 120, a storage unit 130, and input/output interface 140, a display 150, and a communication interface 160.

The electronic device 101 may include various electronic devices capable of verifying a block (or digital data) within a unit time and transferring the verified block (or digital data) to another electronic device in a chain network. The electronic device 101 may include a smartphone, a mobile phone, a notebook, an air conditioner, a note personal computer (PC), a tablet PC, a smart television (TV), a wearable electronic device, and the like. As used herein, the electronic device 101 may be referred to as a node, a terminal, and/or a device.

The bus 110 may be a circuit which connects the above-described elements (e.g., the processor 120, the storage unit 130, the input/output interface 140, the display 150, and/or the communication interface 160) to each other and transmits communication (e.g., control message, data message, and the like) between the elements.

The processor 120 may receive a command from other elements (e.g., the storage unit 130, the input/output interface 140, the display 150, and/or the communication interface 160) through the bus 110 and may process calculations or perform data processing according to the received command. The processor 120 may transmit a command for controlling other elements (e.g., the storage unit 130, the input/output interface 140, the display 150, and/or the communication interface 160) through the bus 110.

The storage unit 130 may store a command and/or data received from other elements (e.g., the input/output interface 140, the display 150, or the communication interface 160) and/or generated by the processor 120 or other elements. The storage unit 130 may include at least one programming modules among a kernel 131, middleware 132, an application programming interface (API) 133, or applications 134. Each of the programming modules may be configured by software, firmware, hardware, and/or a combination of at least two or more thereof.

The kernel 131 may control and/or manage system resources used for performing operations or functions implemented in the remaining programming modules, for example, the middleware 132, the API 133, or the applications 134. The kernel 131 may provide an interface through which the API 133 or the applications 134 can access and control or manage individual elements of the electronic device 101.

The middleware 132 may serve as an intermediary that makes the API 133 or the applications 134 communicate with the kernel 131 to exchange data. In association with task requests received from the applications 134, the middleware 132 may control (for example, scheduling or load-balancing) the task requests by using, for example, a method of assigning a priority to at least one of the applications 134 to use system resources (for example, the bus 110, the processor 120, the storage unit 130, or the like) of the electronic device 101.

The API 133 is an interface through which the applications 134 control a function provided by the kernel 131 or the middleware 132 and may include, for example, at least one interface or function (for example, command) for file control, window control, image processing, or text message control.

According to an embodiment, the applications 134 may include at least one of a blockchain-based application, an application for a smart contract, a distributed ledger technology-based application, and an application for processing digital data (or digital content). According to an embodiment, the applications 134 may be applications related to information exchange between the electronic device 101 and an external electronic device (for example, a first external electronic device 102 and/or a second external electronic device 104). The electronic device 101 and the first external electronic device 102 may be connected wiredly or wirelessly 164, and electronic device 101 and the second external electronic device 104 may be connected through may be connected through a network 162.

The input/output interface 140 may transfer a command or data input by the user through an input/output device (for example, a sensor, a display, a keyboard, or a touch screen) to the processor 120, the storage unit 130, or the communication interface 160 through, for example, the bus 110. For example, the input/output interface 140 may provide, to the processor 120, data associated with a touch of a user input through a touch screen. Further, through an input/output device (for example, a speaker or a display), the input/output interface 140 may output a command or data received from the processor 120, the storage unit 130, or the communication interface 160 through, for example, the bus 110.

The display 150 may display various pieces of information (for example, multimedia data, text data, or the like) to the user.

The communication interface 160 may connect communication between the electronic device 101 and an external device (for example, the first external electronic device 102, the second external electronic device 104, or the server 106). For example, the communication interface 160 may be connected to the network 162 through wireless communication or wired communication, and may communicate with an external device. The wireless communication may include at least one of, for example, Wireless Fidelity (Wi-Fi), Bluetooth™ (BT), near field communication (NFC), global positioning system (GPS), and cellular communication (e.g., sixth generation (6G), fifth generation (5G), Long-Term Evolution (LTE), LTE advanced (LTE-A), code division multiple access (CDMA), wideband CDMA (WCDMA), universal mobile telecommunications service (UMTS), wireless broadband (WiBro), global system for mobile communication (GSM)), and the like. The wired communication may include at least one of, for example, a universal serial bus (USB), a high definition multimedia interface (HDMI), recommended standard 232 (RS-232), and a plain old telephone service (POTS).

According to an embodiment, the network 162 may be a telecommunication network. The telecommunication network may include at least one of a computer network, the Internet, the Internet of Things, and a telephone network. According to an embodiment, protocols (for example, a transport layer protocol, a data link layer protocol, or a physical layer protocol) for communication between the electronic device 101 and external device (for example, the first external device 102 or the second external device 104) may be supported by at least one of the application 134, the API 133, the middleware 132, the kernel 131, and the communication interface 160.

Each of the first and second external electronic devices 102 and 104 may be of a type the same as or different from that of the electronic device 101. In the disclosure, each of the first and second external electronic devices 102 and 104 may be referred to as a node, a terminal, or a device.

According to an embodiment, the server 106 may include a group of one or more servers. According to an embodiment, all or some of the operations (or functions) implemented by the electronic device 101 may be performed by one or a plurality of other electronic devices (for example, the first external electronic device 102, the second external electronic device 104, or the server 106). According to an embodiment, when the electronic device 101 should perform any function or service automatically or in response to a request, the electronic device 101 may make a request for at least some functions related to the service or the function to another device (for example, the first electronic device 102, the second electronic device 104, or the server 106) instead of or in addition to executing the function or the service by itself. Another electronic device (for example, the first electronic device 102, the second electronic device 104, or the server 106) may perform the requested function or an additional function and transfer the result to the electronic device 101. The electronic device 101 may provide the received result as it is or additionally process the received result and provide the requested functions or services. To this end, for example, cloud-computing, distributed-computing, or client-server-computing technology may be used.

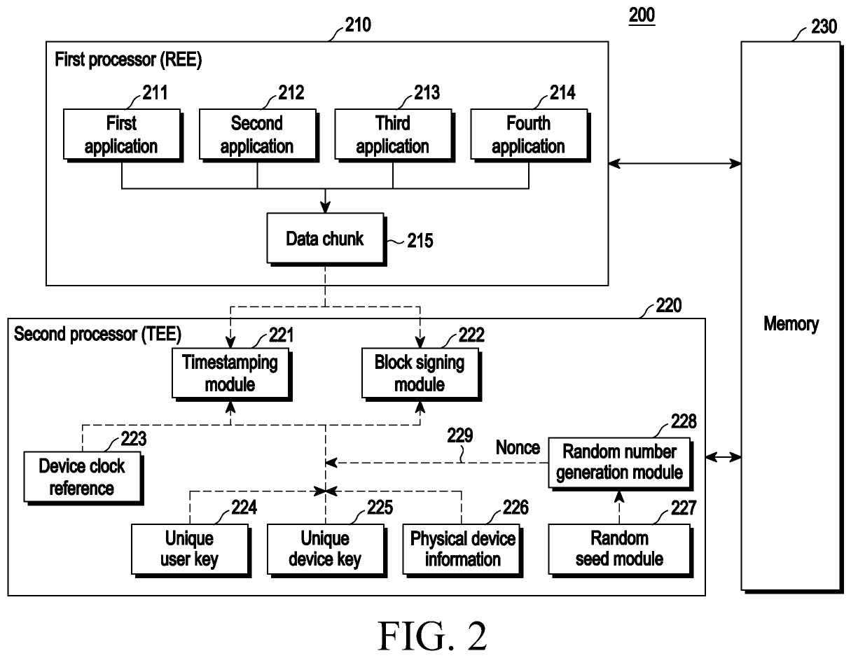

FIG. 2 illustrates an example of a device diagram to describe an operation of an electronic device, according to an embodiment of the disclosure.

Referring to FIG. 2, an electronic device 200 may include a first processor 210 for controlling the operation of the electronic device 200 in a normal execution environment (e.g., a rich execution environment (REE)), a second processor 220 for controlling the operation of the electronic device 200 in a secure execution environment (e.g., a trusted execution environment (TEE)), and a memory 230. According to an embodiment, the general execution environment (e.g., the REE) may refer to an environment in which applications which do not need separate security may be executed on the basis of a normal operating system (OS), and the secure execution environment (e.g., the TEE) may refer to an environment in which at least one application and/or resources which need security are provided on the basis of a secure OS. According to an embodiment, the electronic device 200 may have an isolated secure execution environment (e.g., TEE), as well as, a security technology performed in the normal execution environment (e.g., the REE) to provide a security capability enhanced for a specific application and/or resource. According to an embodiment, the electronic device 200 may switch an operation mode from the normal execution environment (e.g., the REE) to the secure execution environment (e.g., the TEE) to identify and/or sign digital data/content in the isolated secure execution environment (e.g., TEE). According to an embodiment, the electronic device 200 may switch the operation mode from the normal execution environment (e.g., the REE) to the secure execution environment (e.g., the TEE) in response to a request (e.g., an API call) from the first processor 210 for controlling the operation of the electronic device 200 within the normal execution environment (e.g., the REE).

Although FIG. 2 illustrates that the first processor 210 for controlling the operation of the electronic device 200 within the normal execution environment (e.g., the REE) is independent from the second processor 220 for controlling the operation of the electronic device 200 within the secure execution environment (e.g., the TEE), the present disclosure is not limited thereto, and one processor within the electronic device 200 may control both the operations of the electronic device 200 in the normal execution environment (e.g., the REE) and the secure execution environment (e.g., the TEE).

The first processor 210 may perform control to execute at least one of a first application 211, a second application 212, a third application 213, and a fourth application 214 in the normal execution environment (e.g., the REE). For example, the first application 211 may be a blockchain-based application, the second application 212 may be an application for a smart contract, a third application 213 may be a distributed ledger technology-based application, and the fourth application 214 may be an application providing a service configured for trusted data/content. However, the present disclosure is not limited in this regard, and the first to fourth applications 211 to 214 may be and/or may include different types of applications.

The first processor 210 may determine a data chunk 215 for the API call to the second processor 220 within the secure execution environment (e.g., the TEE). The data chunk 215 may include at least one of a block, a contract, trusted data/content, and a blockchain. For example, the data chunk 215 may be a blockchain which should be processed or managed by the blockchain-based application.

The first processor 210 may make a request for generating a block including data for verification of the data chunk 215 to the second processor 220 within the secure execution environment (e.g., the TEE). According to an embodiment, the request may be implemented in the form of an API call.

In the secure execution environment (e.g., the TEE), the second processor 220 may generate tamper-proof data for verification of the data chunk 215 in response to the API call from the first processor 210 and perform signing for the data for verification, so as to generate a block. The second processor 220 may perform control to transmit the generated block to another node (e.g., another electronic device).

The second processor 220 may perform tamper-proof timestamping and/or signing for the data chunk 215 in response to the API call from the first processor 210. The second processor 220 may include a timestamping module 221 for providing tamper-proof timestamping for the data chunk 215 and a block signing module 222 for providing tamper-proof signing for the data chunk 215.

In the secure execution environment (e.g., the TEE), the timestamping module 221 may generate a tamper-proof timestamp for the data chunk 215 on the basis of at least one of a device clock reference 223, key information 224 to 226, and Nonce 229 (e.g., random data). According to an embodiment, the tamper-proof timestamp for the data chunk 215 may be implemented in the form of a propagating timestamp included in a propagation header within the block. The key information 224 to 226 may include at least one of a unique user key 224, a unique device key 225, and physical device information 226. The device clock reference 223 may be a reference clock shared by all electronic devices (e.g., a synchronized clock for satellite communication). According to an embodiment, the timestamping module 221 may encrypt timestamp information on the basis of the device clock reference 223, the key information 224 to 226, and Nonce 229.

The unique user key 224 may be generated and/or managed by the user, stored in a protection area within the device, and then used. In an embodiment, the unique user key 224 may be a user-dependent unique key. The unique device key 225 may be managed and/or stored by a manufacturer of the electronic device 200 as necessary and may be a manufacturer-dependent unique key. The physical device information 226 may be determined during a manufacturing process of the electronic device 200 and managed and/or stored by the manufacturer. In an embodiment, the physical device information 226 may be physical device element information and/or a physical unclonable function (PUF). In an embodiment, the physical device information 226 may be a device hardware (HW)-dependent unique key.

A random seed module 227 may generate a random seed to be provided to a random number generation module 228. According to an embodiment, a random seed may be generated on the basis of external environment information of the electronic device (e.g., temperature, humidity, and the like). The random number generation module 228 may generate Nonce 229 by using the random seed received from the random seed module 227.

In the secure execution environment (e.g., the TEE), the block signing module 222 may perform tamper-proof signing (e.g., add a signature) for the data chunk 215 on the basis of at least one of the device clock reference 223, the key information 224 to 226, and Nonce 229. The key information 224 to 226 may include at least one of the unique user key 224, the unique device key 225, and the physical device information 226. According to an embodiment, the tamper-proof signing (and/or signature) for the data chunk 215 may be implemented in the form of a propagated hash included in a propagation header within the block.

The electronic device 200 may configure a transaction to generate a block, add information of the electronic device 200 to a predecessor field within the propagation header of the block (e.g., self-predecessor when the electronic device 200 is an initially generated node for the block), and/or add a propagated_hash field and a propagating timestamp field within the propagation header of the block. According to an embodiment, the propagated_hash field may hash information which cannot be falsified by the block signing module 222. According to an embodiment, the propagating_timestamp field may be tamper-proof timestamp information generated by the timestamping module 221.

The electronic device 200 may transfer the block to which the predecessor field, the propagated_hash field, and/or the propagating_timestamp field are added to the following node (and/or an external electronic device).

According to an embodiment, after receiving the block from the electronic device 200, the node may verify validity of the block on the basis of propagated hash information generated by the previous node (e.g., the electronic device 200). According to an embodiment, after receiving the block from the electronic device 200, the node may verify validity of the block by comparing propagated hash information generated by the previous node (e.g., the electronic device 200) and propagated hash information generated by a previous node of the previous node.

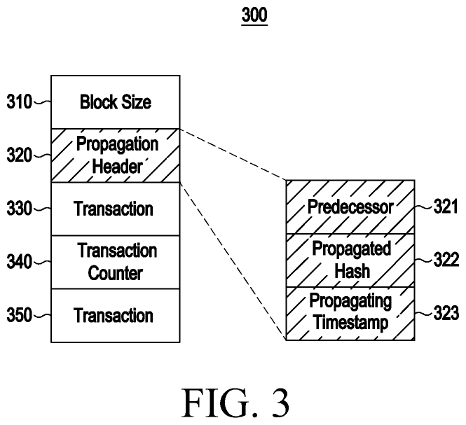

FIG. 3 illustrates an example of a block structure, according to an embodiment of the disclosure.

Referring to FIG. 3, a block 300 may include at least one of a block size 310, a propagation header 320, a first transaction 330, a transaction counter 340, and a second transaction 350. A propagation header 320 may include at least one of a predecessor 321, a propagation hash 322, and a propagating timestamp 323.

The block size 310 may indicate the size of the block 300. For example, the block size 310 may indicate that the block 300 has a size of four (4) bytes (B). However, the present disclosure is not limited in this regard. That is, the block size 310 may indicate that the size of the block 300 is smaller than 4B (e.g., <4B) and/or larger than 4B (e.g., >4B).

The propagation header 320 may include information on verification and/or confirmation for the block 300 to transmit and/or spread the trusted block 300 within a chain network in a predetermined number of units of time. The predecessor 321 may include identifier information of the previous node transmitting the block to the current node (or the electronic device 200). For example, the predecessor 321 may be a public key address used for cryptocurrency.

The propagation hash 322 may be authentication hash information indicating completion of verification and/or confirmation of validity of the block 300 by each node. According to an embodiment, the propagation hash 322 may be hash information processed to be tamper-proof on the basis of at least one of key information of the node (e.g., the unique device key 225, hash key derived on the basis of a user account, and the like), a clock reference of the node (e.g., the device clock reference 223), and Nonce 229. According to an embodiment, the propagation hash 322 may be hash information processed to be tamper-proof on the basis of at least one of key information in a cloud abstracting node (e.g., at least one of the unique user key 224, the unique device key 225, and the physical device information 226), a clock reference of the node (e.g., the device clock reference 223), and Nonce 229. According to an embodiment, the propagation hash 322 may be generated on the basis of the operation of the block signing module 222 of FIG. 2.

The propagating timestamp 323 may be time information at which each node receives the block 300. The propagating timestamp 323 may be timestamp information processed to be tamper-proof on the basis of at least one of key information of the node (e.g., including at least one of the unique user key 224, the unique device key 225, and the physical device information 226), a clock reference of the node (e.g., the device clock reference 223), and Nonce 229. According to an embodiment, the propagating timestamp 323 may be generated on the basis of the operation of the timestamping module 221 of FIG. 2.

Each of the first and second transactions 330 and 350 may be digital data/content exchanged between nodes. For example, the first and second transactions 330 and 350 may include transaction information of bitcoin which a first node transmits to a second node. According to an embodiment, for approval of transaction information included in the first transaction 330, at least one block including the corresponding transaction information may need to be transmitted and/or propagated between nodes. The transaction counter 340 may indicate the number of transactions included in the block 300 (e.g., two (2)).

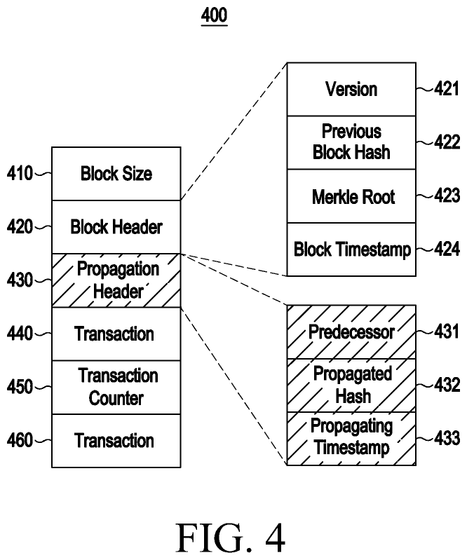

FIG. 4 illustrates another example of the block structure, according to an embodiment of the disclosure.

Referring to FIG. 4, a block 400 may include at least one of a block size 410, a block header 420, a propagation header 430, a first transaction 440, a transaction counter 450, and a second transaction 460. The block header 420 may include at least one of a version 421, a previous block hash 422, a Merkle root 423, and a block timestamp 424. The propagation header 320 may include at least one of a predecessor 321, a propagation hash 322, and a propagating timestamp 323.

The block 400 illustrated in FIG. 4 may further include the block header 420 compared to the block 300 illustrated in FIG. 3. Since description of the elements 410 and 430 to 460 within the block 400 except for the block header 420 is the same as the description made with reference to FIG. 3, the description thereof is omitted.

The version 421 may indicate version information of digital data/content (e.g., bitcoin) and the previous block hash 422 may indicate a hash value of a previous block. The Merkle root 423 may indicate a root node value of a Merkle tree used for protecting the data and may be used to identify whether a specific transaction is included in the block 400. The block timestamp 424 may indicate information on a date and/or time at which the block 400 is generated.

According to an embodiment, the block header 420 may further include bits indicating difficulty of mining and Nonce related to the answer to mining. For example, when a hash of the header is calculated in the state in which a random Nonce value is put into the header, it may be determined that mining is successful if the hash value is smaller than any value expressed by bits. For example, miners may calculate the hash of the header while randomly applying the Nonce value and repeat an action of comparing the calculated hash value with bits.

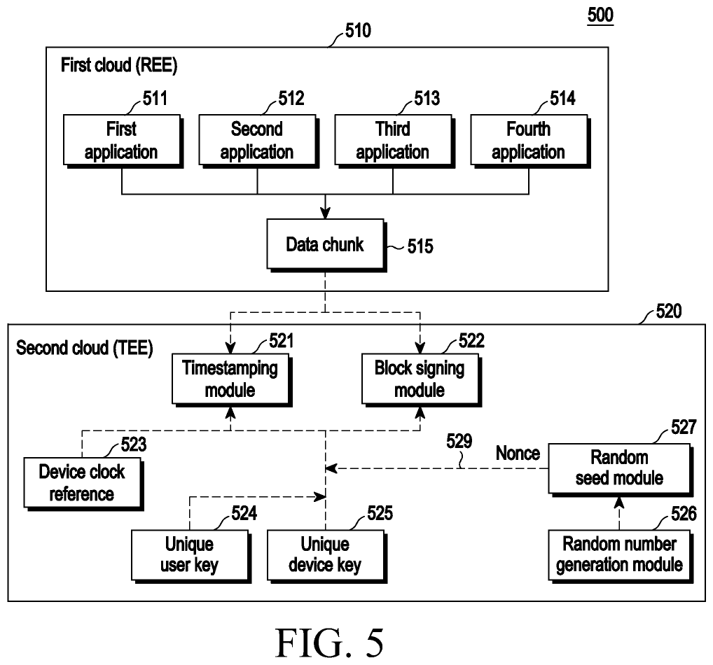

FIG. 5 illustrates another example of the device diagram to describe the operation of the electronic device, according to an embodiment of the disclosure.

Referring to FIG. 5, a first cloud 510 may control the operation of an electronic device 500 in the normal execution environment (e.g., the REE), and a second cloud 520 may control the operation of the electronic device 500 in the secure execution environment (e.g., the TEE). While at least one processor implemented in the electronic device 200 may control the operation of the electronic device 200 in the normal execution environment (e.g., the REE) and the secure execution environment (e.g., the TEE) as described with reference to FIG. 2, a method by a cloud-based user service by the first cloud 510 and the second cloud 520 processes and protects a block is described with reference to FIG. 5.

Although FIG. 5 illustrates that the first cloud 510 for controlling the operation of the electronic device 500 within the normal execution environment (e.g., the REE) is independent from the second cloud 520 for controlling the operation of the electronic device 500 within the secure execution environment (e.g., the TEE), the present disclosure is not limited thereto and one cloud may control the operations of the electronic device 500 in the normal execution environment (e.g., the REE) and the secure execution environment (e.g., the TEE).

The first cloud 510 may perform control to execute at least one of a first application 511, a second application 512, a third application 513, and a fourth application 514 in the normal execution environment (e.g., the REE). For example, the first application 511 may be a blockchain-based application, the second application 512 may be an application for a smart contract, a third application 513 may be a distributed ledger technology-based application, and the fourth application 514 may be an application providing a service configured for trusted data/content. However, the present disclosure is not limited in this regard, and the first to fourth applications 511 to 514 may be and/or may include different types of applications.

The first cloud 510 may determine a data chunk 515 for calling the second cloud 520 within the secure execution environment (e.g., the TEE). The data chunk 515 may include at least one of a block, a contract, trusted data/content, and a blockchain. For example, the data chunk 515 may be a blockchain that is to be processed and/or managed by the blockchain-based application.

In the secure execution environment (e.g., the TEE), the second cloud 520 may generate tamper-proof data for verification of the data chunk 215 in response to the call from the first cloud 510 and perform signing for the data for verification, so as to generate a block. The second cloud 520 may perform control to transmit the generated block to another node (or another electronic device).

The second cloud 520 may perform tamper-proof timestamping and/or signing for the data chunk 515 in response to the API call from the first cloud 510. The second cloud 520 may include a timestamping module 521 for providing tamper-proof timestamping for the data chunk 515 and a block signing module 522 for providing tamper-proof signing for the data chunk 515.

In the secure execution environment (e.g., the TEE), the timestamping module 521 may generate a tamper-proof timestamp for the data chunk 515 on the basis of at least one of a device clock reference 523, key information 524 to 525, and Nonce 529 (e.g., random data). According to an embodiment, the tamper-proof timestamp for the data chunk 515 may be implemented in the form of a propagating timestamp included in a propagation header within the block. The key information 524 to 525 may include at least one of a unique user key 524 and a unique device key 525. According to an embodiment, the timestamping module 521 may encrypt timestamp information on the basis of the device clock reference 523, the key information 524 to 525, and Nonce 529.

The unique user key 524 may be generated and/or managed by the user, stored in a protection area within the device, and then used. In an embodiment, the unique user key 524 may be a user-dependent unique key. In an embodiment, the unique device key 525 may be managed and/or stored by a manufacturer of the electronic device 500 as necessary and may be a manufacturer-dependent unique key.

A random seed module 526 may generate a random seed to be provided to a random number generation module 527. According to an embodiment, a random seed may be generated on the basis of external environment information of the electronic device (e.g., temperature, humidity, and the like). The random number generation module 527 may generate Nonce 529 by using the random seed received from the random seed module 526.

In the secure execution environment (e.g., the TEE), the block signing module 522 may perform tamper-proof signing (e.g., add a signature) for the data chunk 515 on the basis of at least one of the device clock reference 523, the key information 524 to 525, and Nonce 529. According to an embodiment, the tamper-proof signing (and/or signature) for the data chunk 515 may be implemented in the form of a propagated hash included in a propagation header within the block.

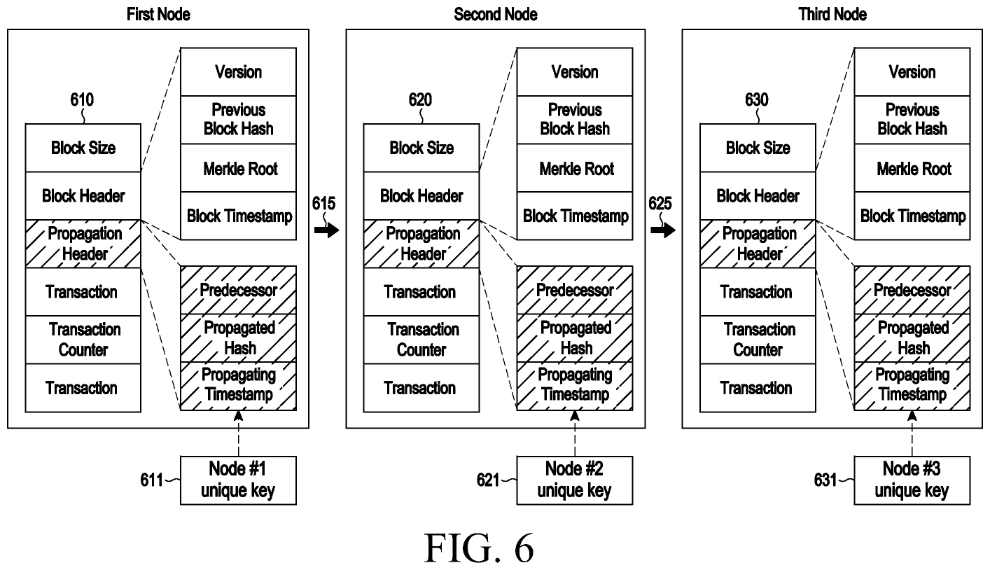

FIG. 6 illustrates an example of transmitting a block between nodes in a network, according to an embodiment of the disclosure.

In the disclosure, each node within the network may be implemented as an independent electronic device. Referring to FIG. 6, a first node may generate a first block 610 including a propagation header containing a predecessor field having information of the first node, a propagated hash field generated on the basis of an unique key 611 of the first node, and a propagating timestamp field. The first node may transfer the first block 610 to a second node in operation 615.

The second node may identify that a previous node is the first node on the basis of the predecessor field included in the first block 610 and identify that the first block 610 is a valid block on the basis of the propagated hash field and the propagating timestamp field. According to an embodiment, the second node may identify a time point at which the first node signs the first block 610 on the basis of the propagation header included in the first block 610. According to an embodiment, the second node may verify a hash value included in the first block 610 by using a public key. According to an embodiment, the public key may be a key for verifying a hash value shared between the nodes within a chain network.

When the second node determines that the first block 610 is valid, the second node may configure a propagation header on the basis of the information of the second node and generate a second block 620 including the configured propagation header. The second node may generate the second block 620 including a propagation header containing a predecessor field having the information of the second node, a propagated hash field generated on the basis of an unique key 621 of the second node, and a propagating timestamp field. The second node may transfer the second block 620 to a third node in operation 625.

The third node may identify that a previous node is the second node on the basis of the predecessor field included in the second block 620 and identify that the second block 620 is a valid block on the basis of the propagated hash field and the propagating timestamp field included in the second block 620. According to an embodiment, the third node may identify a time point at which the second node signs the second block 620 on the basis of the propagation header included in the second block 620. According to an embodiment, the third node may verify a hash value included in the second block 620 by using a public key.

When the third node determines that the second block 620 is valid, the third node may configure a propagation header on the basis of the information of the third node and generate a third block 630 including the configured propagation header. The third node may generate the third block 630 including a propagation header containing a predecessor field having the information of the third node, a propagated hash field generated on the basis of an unique key 631 of the third node, and a propagating timestamp field. The third node may transfer the third block 630 to a next node.

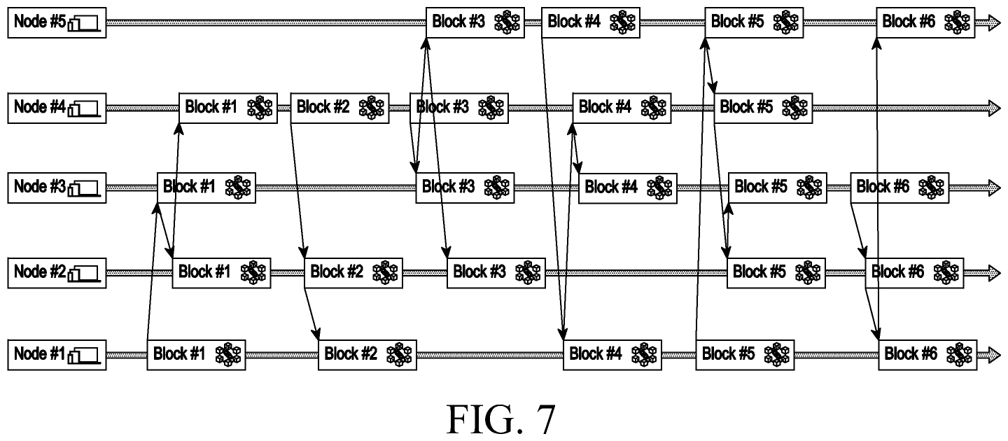

FIG. 7 illustrates an example of approving a plurality of blocks in a network according to an embodiment of the disclosure.

Referring to FIG. 7, a chain network may include, for example, five nodes (node #1 to node #5). Each of the five nodes (node #1 to node #5) may be implemented as an independent electronic device.

The first node (node #1) may generate a first block (block #1) and transmit the first block (block #1) to the third node (node #3). The third node (node #3) may perform timestamping and/or signing for the first block (block #1) and transmit the first block (block #1) to the second node (node #2). The second node (node #2) may perform timestamping and/or signing for the first block (block #1) and transmit the first block (block #1) to the fourth node (node #4). According to an embodiment, when the first node (node #1), the third node (node #3), the second node (node #2), and the fourth node (node #4) which are more than half of the five nodes (node #1 to node #5) have completely verified and/or signed the first block (block #1), it may be approved (or considered) that the first block (block #1) is valid within the chain network. According to an embodiment, the fourth node (node #4) may issue the first block (block #1) which has been approved to be valid.

The fourth node (node #4) may generate a second block (block #2) and transmit the second block (block #2) to the second node (node #2). The second node (node #2) may perform timestamping and/or signing for the second block (block #2) and transmit the second block (block #2) to the first node (node #1). According to an embodiment, when the first node (node #1), the second node (node #2), and the fourth node (node #4) which are more than half of the five nodes (node #1 to node #5) have completely verified and/or signed the second block (block #2), it may be approved (or considered) that the second block (block #2) is valid within the chain network. According to an embodiment, the first node (node #1) may issue the second block (block #2) which has been approved to be valid.

As illustrated in FIG. 7, nodes which are more than half of the five nodes (node #1 to node #5) have completely verified and/or signed the corresponding block (one of block #1 to block #6), it may be considered that the corresponding block (one of block #1 to block #6) has been approved and one of the five nodes (node #1 to node #5) may issue the approved block (one of block #1 to block #6).

In FIG. 7, for convenience of description, it is considered that, when nodes which are more than half of the five nodes (node #1 to node #5) have completely verified and/or signed the corresponding block (one of block #1 to block #6), the corresponding block (one of block #1 to block #6) has been approved, but the technical idea of the disclosure is not limited thereto and whether to approve a specific block may be determined according to a ratio of various verifications and/or signatures by a plurality of nodes.

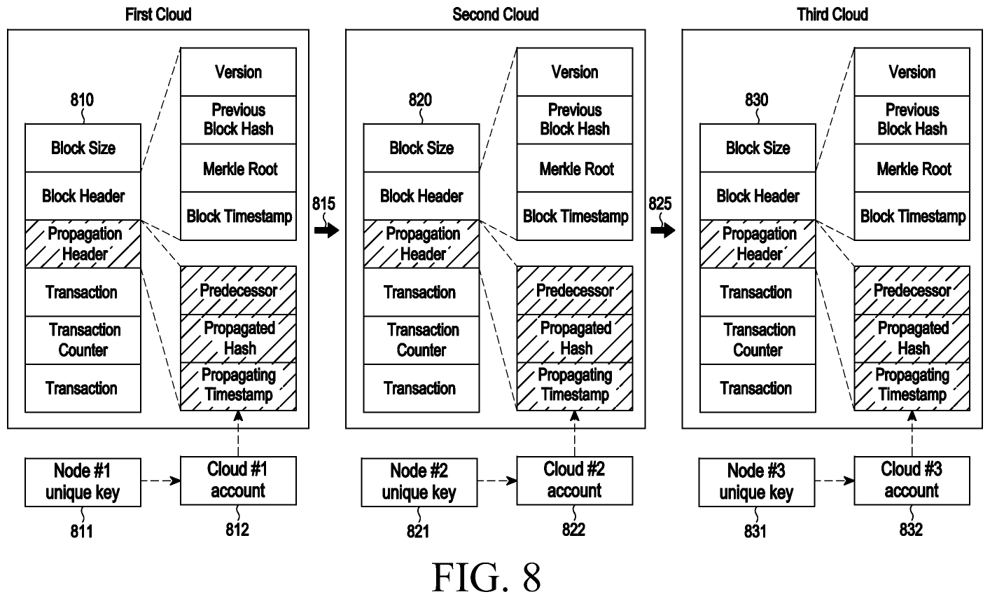

FIG. 8 illustrates another example of transmitting a block between nodes in the network, according to an embodiment of the disclosure.

Referring to FIG. 8, a first cloud may generate a first block 810 including a propagation header containing a predecessor field having information of a first node, a propagated hash field generated on the basis an account 812 of the first cloud, and a propagating timestamp field. According to an embodiment, the account 812 of the first cloud may be generated on the basis of a unique key 811 of the first node controlled by the first cloud. The first cloud may transfer the first block 810 to a second cloud in operation 815.

A second cloud may identify that a previous node is the second node on the basis of the predecessor field included in the first block 810 and identify that the first block 810 is a valid block on the basis of the propagated hash field and the propagating timestamp field included in the first block 810. According to an embodiment, the second cloud may identify a time point at which the first cloud signs the first block 810 on the basis of the propagation header included in the first block 810. According to an embodiment, the second cloud may verify a hash value included in the first block 810 by using a public key.

When the second cloud determines that the first block 810 is valid, the second cloud may configure a propagation header on the basis of information on a second node and information on the second cloud and generate a second block 820 including the configured propagation header. The second cloud may generate the second block 820 including a propagation header containing a predecessor field having information on the second node, a propagated hash field generated on the basis of an account 822 of the second cloud, and a propagating timestamp field. The second cloud may transfer the second block 820 to a third cloud in operation 825. According to an embodiment, the account 822 of the second cloud may be generated on the basis of a unique key 821 of the second node controlled by the second cloud.

The third cloud may identify that a previous node is the second node on the basis of the predecessor field included in the second block 820 and identify that the second block 820 is a valid block on the basis of the propagated hash field and the propagating timestamp field included in the second block 820. According to an embodiment, the third cloud may identify a time point at which the second cloud signs the second block 820 on the basis of the propagation header included in the second block 820. According to an embodiment, the third cloud may verify a hash value included in the second block 820 by using a public key.

When the third cloud determines that the second block 820 is valid, the third cloud may configure a propagation header on the basis of information on a third node and the third cloud and generate a third block 830 including the second block 820 and the configured propagation header. The third cloud may generate the third block 830 including a propagation header containing a predecessor field having information on the third node, a propagated hash field generated on the basis of an account 832 of the third cloud, and a propagating timestamp field. According to an embodiment, the account 832 of the third cloud may be generated on the basis of a unique key 831 of the third node controlled by the third cloud. The third cloud may transfer the third block 830 to a next node.

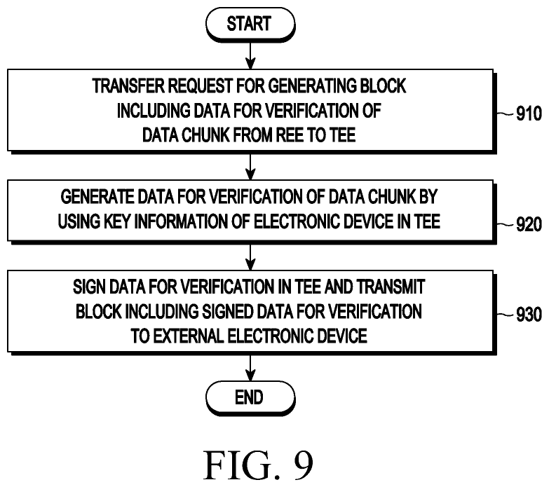

FIG. 9 is a flowchart illustrating a method of operating an electronic device, according to an embodiment of the disclosure. In an embodiment, at least one of operation 910 to operation 930 may be omitted, sequences of some operations may be changed, or another operation may be added.

Referring to FIG. 9, in operation 910, an electronic device (for example, 101 of FIG. 1, 200 of FIG. 2, or 500 of FIG. 5) may transfer a request for generating a block including data for verification of a data chunk from a normal execution environment (REE) to a secure execution environment (TEE). In operation 920, the electronic device (for example, 101 of FIG. 1, 200 of FIG. 2, or 500 of FIG. 5) may generate the data for verification of the data chunk by using key information of the electronic device in the secure execution environment (TEE). In operation 930, the electronic device (for example, 101 of FIG. 1, 200 of FIG. 2, or 500 of FIG. 5) may sign the data for verification in the secure execution environment (TEE) and transmit the block including the signed data for verification to an external electronic device.

According to an embodiment, the data chunk may include at least one of a block, a contact, trusted data, content, and blockchain. According to an embodiment, the key information may include at least one of a unique user key of the electronic device, a unique device key of the electronic device, and physical device information acquired when the electronic device is manufactured.

According to an embodiment, the data for verification may include timestamp information for the block configured to be tamper-proof on the basis of at least one of a reference clock and nonce, and the key information, and hash information for the block configured to be tamper-proof, based on at least one of the reference clock and the nonce, and the key information.

According to an embodiment, the block including the signed data for verification may include a block size indicating a size of the block, a transaction indicating digital data exchanged between nodes within a network, and a transaction counter indicating a number of transactions included in the block. According to an embodiment, the timestamp information for the block and the hash information for the block may be included in the propagation header within the block. According to an embodiment, the propagation header within the block may further include identifier information of a previous node.

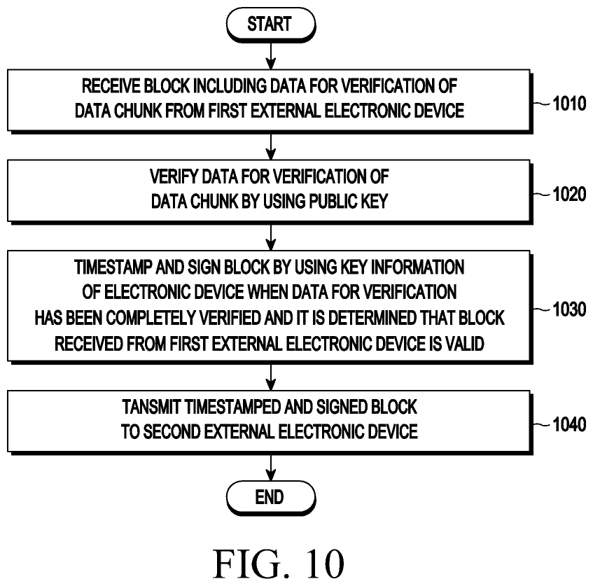

FIG. 10 is a flowchart illustrating a method of operating an electronic device according to an embodiment of the disclosure. In an embodiment, at least one of operation 1010 to operation 1040 may be omitted, sequences of some operations may be changed, or another operation may be added.

Referring to FIG. 10, in operation 1010, an electronic device (for example, 101 of FIG. 1, 200 of FIG. 2, or 500 of FIG. 5) may receive a block including data for verification of a data chunk from a first external electronic device. In operation 1020, the electronic device (for example, 101 of FIG. 1, 200 of FIG. 2, or 500 of FIG. 5) may verify the data for verification of the data chunk by using a public key. In operation 1030, when the data for verification has been completely verified and it is determined that the block received from the first external electronic device is valid, the electronic device (for example, 101 of FIG. 1, 200 of FIG. 2, or 500 of FIG. 5) may timestamp and sign the block by using key information of the electronic device. In operation 1040, the electronic device (for example, 101 of FIG. 1, 200 of FIG. 2, or 500 of FIG. 5) may transmit the timestamped and signed block to a second external electronic device.

According to an embodiment, the data for verification may include timestamp information for the block configured to be tamper-proof, based on at least one of a reference clock and nonce, and the key information. According to an embodiment, the data for verification may include hash information for the block configured to be tamper-proof, based on at least one of the reference clock and the nonce, and the key information. According to an embodiment, the key information may include at least one of a unique user key of the electronic device, a unique device key of the electronic device, and physical device information acquired when the electronic device is manufactured. According to an embodiment, the data chunk may include at least one of a block, a contact, trusted data, content, and blockchain.

According to an embodiment, the block may include a block size indicating a size of the block, a transaction indicating digital data exchanged between nodes within a network, a transaction counter indicating a number of transactions included in the block, and a propagation header including the data for verification of the block to transmit the block within the network in units of predetermined time.

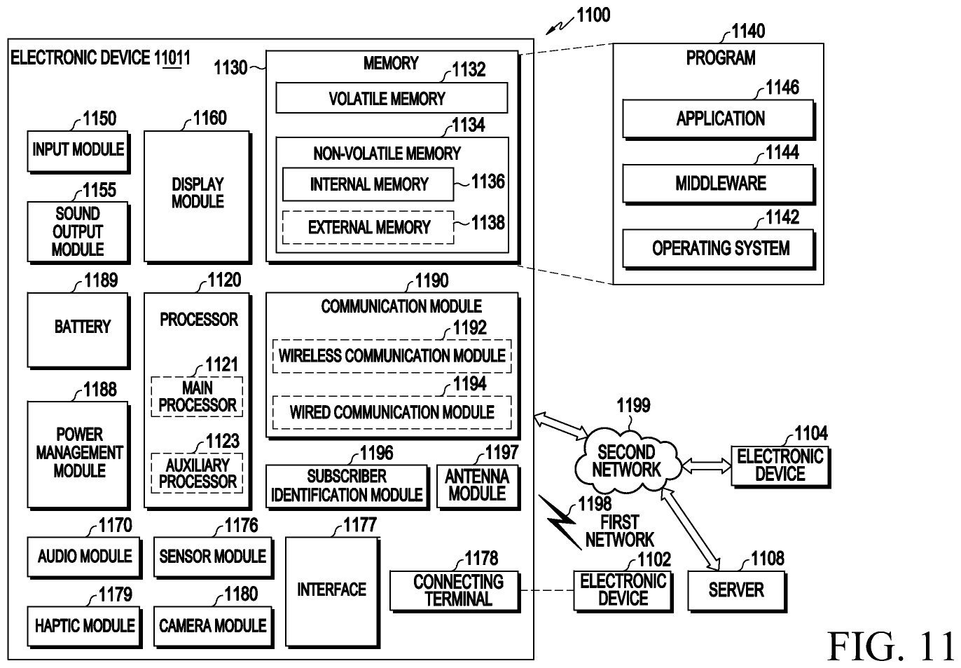

FIG. 11 is a block diagram illustrating an electronic device 1101 in a network environment 1100 according to various embodiments.

Referring to FIG. 11, the electronic device 1101 in the network environment 1100 may communicate with an electronic device 1102 via a first network 1198 (e.g., a short-range wireless communication network), or at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In some embodiments, at least one of the components (e.g., the connecting terminal 1178) may be omitted from the electronic device 1101, or one or more other components may be added in the electronic device 1101. In some embodiments, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to one embodiment, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an image signal processor or a communication processor) may be implemented as part of another component (e.g., the camera module 1180 or the communication module 1190) functionally related to the auxiliary processor 1123. According to an embodiment, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment, the display module 1160 may include a touch sensor adapted to detect a touch, or a pressure sensor adapted to measure the intensity of force incurred by the touch.

The audio module 1170 may convert a sound into an electrical signal and vice versa. According to an embodiment, the audio module 1170 may obtain the sound via the input module 1150, or output the sound via the sound output module 1155 or a headphone of an external electronic device (e.g., an electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the electronic device 1102). According to an embodiment, the connecting terminal 1178 may include, for example, a HDMI connector, a USB connector, a SD card connector, or an audio connector (e.g., a headphone connector).

The haptic module 1179 may convert an electrical signal into a mechanical stimulus (e.g., a vibration or a movement) or electrical stimulus which may be recognized by a user via his tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, image signal processors, or flashes.

The power management module 1188 may manage power supplied to the electronic device 1101. According to one embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device 1104 via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the mmWave band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1197 may transmit or receive a signal or power to or from the outside (e.g., the external electronic device) of the electronic device 1101. According to an embodiment, the antenna module 1197 may include an antenna including a radiating element composed of a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 (e.g., the wireless communication module) from the plurality of antennas. The signal or the power may then be transmitted or received between the communication module 1190 and the external electronic device via the selected at least one antenna. According to an embodiment, another component (e.g., a radio frequency integrated circuit (RFIC)) other than the radiating element may be additionally formed as part of the antenna module 1197.

According to various embodiments, the antenna module 1197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the electronic devices 1102 or 1104 may be a device of a same type as, or a different type, from the electronic device 1101. According to an embodiment, all or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In another embodiment, the external electronic device 1104 may include an internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

While this invention has been described with reference to illustrative embodiments, this description is not intended to be construed in a limiting sense. Various modifications and combinations of the illustrative embodiments, as well as other embodiments of the invention, may be apparent to persons skilled in the art upon reference to the description. It is therefore intended that the appended claims encompass any such modifications or embodiments.

What is claimed is:

1. An electronic device comprising:
a memory;
a first processor coupled to the memory and configured to control the electronic device in a normal execution environment (REE); and
a second processor coupled to the memory and configured to control the electronic device in a secure execution environment (TEE),
wherein the first processor in the REE is configured to transfer, to the second processor in the TEE, a request for generating a block comprising verification data of a data chunk, and
wherein the second processor is configured to generate the verification data of the data chunk by using key information of the electronic device, sign the verification data, and transmit, to an external electronic device, the block comprising the signed verification data.

2. The electronic device of claim 1, wherein the verification data comprises:
timestamp information for the block configured to be tamper-proof, based on the key information and at least one of a reference clock and nonce; and
hash information for the block configured to be tamper-proof, based on the key information and at least one of the reference clock and the nonce.

3. The electronic device of claim 1, wherein the key information comprises at least one of a unique user key of the electronic device, a unique device key of the electronic device, and physical device information acquired during manufacturing of the electronic device.

4. The electronic device of claim 2, wherein the block comprising the signed verification data comprises:
a block size indicating a size of the block;
at least one transaction indicating digital data exchanged between nodes within a network; and
a transaction counter indicating a number of transactions in the block.

5. The electronic device of claim 4, wherein the block comprising the signed verification data comprises a propagation header comprising verification data of the block such that the block is transmitted in the network within a predetermined number of units of time.

6. The electronic device of claim 5, wherein the timestamp information for the block and the hash information for the block are included in the propagation header in the block.

7. The electronic device of claim 5, wherein the propagation header further comprises identifier information of a previous node.

8. The electronic device of claim 1, wherein the data chunk is comprised by at least one of the block, a contract, trusted data, content, and a blockchain.

9. An electronic device, comprising:
a communication circuit; and
at least one processor communicatively coupled to the communication circuit,
wherein the at least one processor is configured to:
receive, from a first external electronic device through the communication circuit, a block comprising verification data of a data chunk;
verify the verification data of the data chunk by using a public key; and
perform control to, based on the verification data being verified and the block received from the first external electronic device being determined to be valid, timestamp and sign the block by using key information of the electronic device.

10. The electronic device of claim 9, wherein the at least one processor is further configured to perform control to transmit, to a second external electronic device through the communication circuit, the timestamped and signed block.

11. The electronic device of claim 9, wherein the verification data comprises:
timestamp information for the block configured to be tamper-proof, based on the key information and at least one of a reference clock and nonce; and
hash information for the block configured to be tamper-proof, based on the key information and at least one of the reference clock and the nonce.

12. The electronic device of claim 9, wherein the key information comprises at least one of a unique user key of the electronic device, a unique device key of the electronic device, and physical device information acquired during manufacturing of the electronic device.

13. The electronic device of claim 9, wherein the block comprising the signed verification data comprises:
a block size indicating a size of the block;
at least one transaction indicating digital data exchanged between nodes within a network;
a transaction counter indicating a number of transactions in the block; and
a propagation header comprising verification data of the block such that the block is transmitted in the network within a predetermined number of units of time.

14. The electronic device of claim 9, wherein the data chunk is comprised by at least one of the block, a contract, trusted data, content, and a blockchain.

15. A method of operating an electronic device, comprising:
transferring, from a normal execution environment (REE) to a secure execution environment (TEE), a request for generating a block comprising verification data of a data chunk;
generating the verification data of the data chunk by using key information of the electronic device in the TEE;
signing the verification data in the TEE; and
transmitting, to an external electronic device, the block comprising the signed verification data.

16. The method of claim 15, wherein the verification data comprises:
timestamp information for the block configured to be tamper-proof, based on the key information and at least one of a reference clock and nonce; and
hash information for the block configured to be tamper-proof, based on the key information and at least one of the reference clock and the nonce.

17. The method of claim 15, wherein the key information comprises at least one of a unique user key of the electronic device, a unique device key of the electronic device, and physical device information acquired during manufacturing of the electronic device.

18. The method of claim 15, wherein the block comprising the signed verification data comprises:
a block size indicating a size of the block;
at least one transaction indicating digital data exchanged between nodes within a network;
a transaction counter indicating a number of transactions in the block; and
a propagation header comprising verification data of the block such that the block is transmitted in the network within a predetermined number of units of time.

19. A method of operating an electronic device, comprising:
receiving, from a first external electronic device, a block comprising verification data of a data chunk;
verifying the verification data of the data chunk by using a public key; and
based on the verification data being verified and the block received from the first external electronic device being valid, timestamping and signing the block by using key information of the electronic device.

20. The method of claim 19, further comprising:
transmitting, to a second external electronic device, the timestamped and signed block.
